(19) United States
(12) Patent Application Publication
(10) Pub. No.: US 2017/0308561 A1
(43) Pub. Date: Oct. 26, 2017

(54) INDEXING AND SEQUENTIALLY STORING VARIABLE-LENGTH DATA TO FACILITATE REVERSE READING

(71) Applicant: LinkedIn Corporation, Mountain View, CA (US)

(72) Inventor: Sanjay Sachdev, San Jose, CA (US)

(73) Assignee: LinkedIn Corporation, Mountain View, CA (US)

(21) Appl. No.: 15/135,402

(22) Filed: Apr. 21, 2016

(51) Int. Cl. G06F 17/30

(52) U.S. Cl. CPC G06F 17/30336

(57) ABSTRACT

A system, method, and apparatus are provided for indexing and sequentially storing variable-length data in a manner that facilitates reverse reading. Each entry stored in a log file, database, or other repository includes a data record having a fixed number of keys, a key offset corresponding to each key, and size metadata identifying a size of the data record (and possibly the key offsets). Each key offset is an offset to another entry (e.g., the matching key offset of the entry) whose data record features the same value for the corresponding key. An index identifies, for each given value of each key, an index offset to a first entry (e.g., the most recently stored entry) that has the given value for that key. Retrieving records matching a particular key value therefore simply involves following the corresponding index offset and then some number of key offsets.

### RELATED APPLICATION

The subject matter of this application is related to the subject matter in co-pending U.S. patent application Ser. No. 14/988,444, entitled “Facilitating Reverse Reading of Sequentially Stored, Variable-Length Data.”

### BACKGROUND

This disclosure relates to the field of computer systems and data storage. More particularly, a system, method, and apparatus are provided for indexing and sequentially storing variable-length data in a manner that facilitates reverse reading of the data and allows for rapid key-specific data retrieval.

Variable-length data are stored in many types of applications and computing environments. For example, events that occur on a computer system, perhaps during execution of a particular application, are often logged and stored sequentially (e.g., according to timestamps indicating when they occurred) in log files, log-structured databases, or other repositories. Because different information is typically recorded for different events (e.g., different system metrics or application metrics), the records often have varying lengths.

When reading the recorded data in the same order it was written, it is relatively easy to quickly navigate the data and proceed from one record to the next, to find a requested record or for some other purpose. However, when attempting to scan the data in reverse order (e.g., to find the most recent record of a particular type or containing particular information), the task is more difficult because the storage schemes typically are not designed to enhance reverse navigation or scanning.

### DESCRIPTION OF THE FIGURES

FIG. 1 is a block diagram depicting a system in which variable-length data is sequentially stored in a manner that facilitates reverse reading, in accordance with some embodiments.

FIGS. 2A-B comprise a flow chart illustrating a method of facilitating reverse reading of sequentially stored variable-length data, in accordance with some embodiments.

FIG. 3 is a block diagram depicting sequential storing of variable-length data to facilitate reverse reading, in accordance with some embodiments.

FIG. 4 is a block diagram depicting indexed storage of variable-length data to facilitate reverse reading, in accordance with some embodiments.

FIG. 5 is a flow chart illustrating a method of appending a new entry to a data repository of sequentially stored, variable-length data, in accordance with some embodiments.

FIG. 6 is a flow chart illustrating a method of retrieving one or more sequentially stored variable-length records having a particular key value, in accordance with some embodiments.

FIG. 7 depicts an apparatus for facilitating reverse reading of sequentially stored variable-length data and/or indexing and sequentially storing such data, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

### Facilitating Reverse Reading of Sequentially Stored Variable-Length Data

In some embodiments, a system, method, and apparatus are provided for facilitating reverse reading of sequentially stored variable-length data records. Reading the data in reverse means reading, scanning, or otherwise navigating through the records in the reverse order from in which they were stored. Because the records are of variable lengths, there may be wide variation in the sizes of the records.

In these embodiments, an efficient scheme is implemented to make it easier and faster to determine the size of a record, thereby allowing a reverse reader to quickly move to the beginning of the record in order to read the record and/or to continue the reverse reading process at the next record in reverse order.

In particular, after the record is stored in sequential order, the length of the record is stored with variable-length quantity (VLQ) encoding. With VLQ encoding, a binary representation of the record length (in bytes) is divided into 7-bit partitions. Each partition is stored in an 8-bit octet in which the most significant (or highest-order) bit indicates whether another octet follows the current one.

Specifically, if the record length requires more than one octet (i.e., at least 128 (or 2⁷) bytes were needed to store the record), every octet except the last octet, which stores the least significant bits of the record length, will have a first value (e.g., 1) as the most significant bit (MSB), while the last octet has a second value (e.g., 0) as the most significant bit. If the record length requires only one octet to store (i.e., the record is less than 128 bytes long), that length is stored with the second value (e.g., 0) as the most significant bit.

However, records that are 128 bytes long, or longer, will still be of varying lengths, and current computing systems will require up to a total of ten octets (or bytes) to store a value representing the length (or size) of a given data record. In particular, a computer or other device that features a 64-bit processor will require up to ten octets to store a 64-bit value (with each octet containing up to 7 of the 64 bits).

This scheme works fine when reading or scanning sequentially stored variable-length data records in the order in which they were stored, because each octet storing a portion of the record's length can be consumed in order and the most significant bits will indicate when the record length value is complete. However, when reading the data in reverse order, the most significant bit of the final octet in the record length (i.e., the first octet that would be encountered when reading in reverse order) will always be 0 and the reader cannot immediately determine how many octets were used to store the record length.

Therefore, in some embodiments, when a variable-length record is stored, the record's length is stored afterward with VLQ encoding, and one additional byte is conditionally formatted and stored after the record length. Specifically, if the record length was stored in one octet/byte (i.e., the record is less than 128 bytes long), which has 0 as the most significant bit, nothing further is done. However, if more than one octet/byte was required to store the record length, then one additional byte is configured and stored after the record length. This additional byte stores the size (in bytes) of the record length, and the value 1 in its most significant bit. This additional byte may be said to store a “size of the size” value, because it stores the size (or length) of the value that identifies the size (or length) of the corresponding record. The “size of the size” byte and the VLQ-encoded record length may be collectively termed ‘size metadata’ for the accompanying record (i.e., the record that precedes the metadata).

When reverse-reading the sequentially stored variable-length data, from the end of the collection of records (e.g., at the end-of-file marker) or at the starting location of the most recently read record, the next byte in reverse order from the current offset is read. If its most significant bit is 0, the byte stores the size of the preceding record (the next record in reverse order) and the reader can identify the beginning of the record by subtracting that size (in bytes) from its current offset. If the most significant bit is 1, the lower seven bits identify the size of the record length value (in bytes). By subtracting that size from the current offset, the reader can identify the start of the VLQ-encoded record length. The record length can then be read to identify the length of the record (in bytes), which can be subtracted from the offset of the start of the VLQ-encoded record length to find the start of the record.

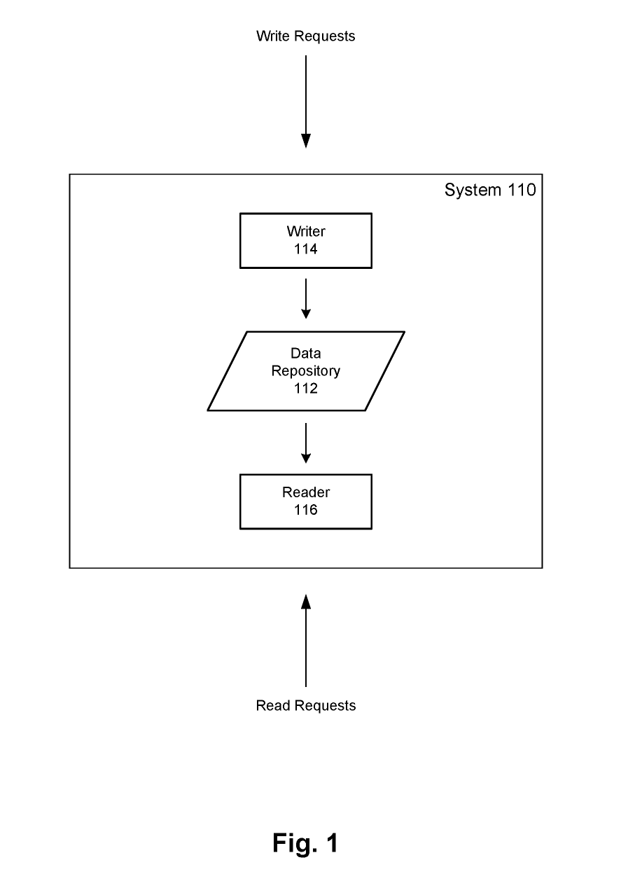

FIG. 1 is a block diagram depicting a system in which variable-length data is sequentially stored in a manner that facilitates reverse reading, in accordance with some embodiments.

System 110 of FIG. 1 includes data repository 112, which may be a log-structured database, a sequential log file, or some other entity. Of note, the repository specifically stores variable-length records in sequential manner (e.g., based on timestamps and/or other indicia). The records may contain different types of data in different implementations, without exceeding the scope of embodiments described herein.

System 110 also includes writer 114 and reader 116. Writer 114 writes new records to data repository 112 in response to write requests, with each new record being stored (immediately) after the previously stored record. Reader 116 traverses (e.g., and reads) records in reverse order from the data repository in response to read requests. Reader 116 may also traverse, navigate, and/or read records in the order in which they are stored, but in current embodiments the reader frequently or regularly is tasked to reverse-navigate the stored data. The reader may navigate the stored data (in either direction) not only to search for one or more desired records, but also to construct (or help construct) an index, linked list, or other structure, or for some other purpose (e.g., to purge stale data, to compress the stored data). Writer 114 and reader 116 may be separate code blocks, computer processes, or other logic entities, or may be separate portions of a single entity.

Write requests and read requests may be received from various entities, including computing devices co-located with and/or separate from system 110, other processes (e.g., applications, services) executing on the same computer system(s) that include system 110, and/or other entities.

For example, system 110 of FIG. 1 may be part of a data center or other cooperative collection of computing resources, and include additional or different components in different embodiments. Thus, the system may include storage components other than data repository 112, and may include processing components, communication resources, and so on. Although only a single instance of a particular component of system 110 may be illustrated in FIG. 1, it should be understood that multiple instances of some or all components may be employed. In particular, system 110 may be replicated within a given computing environment, and/or multiple instances of a component of the system may be employed.

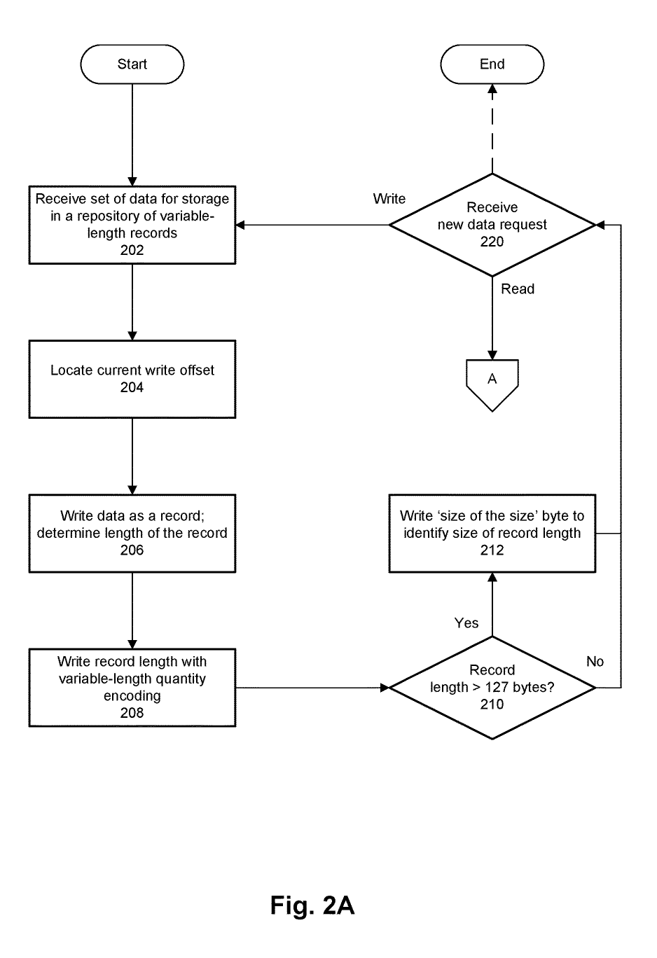

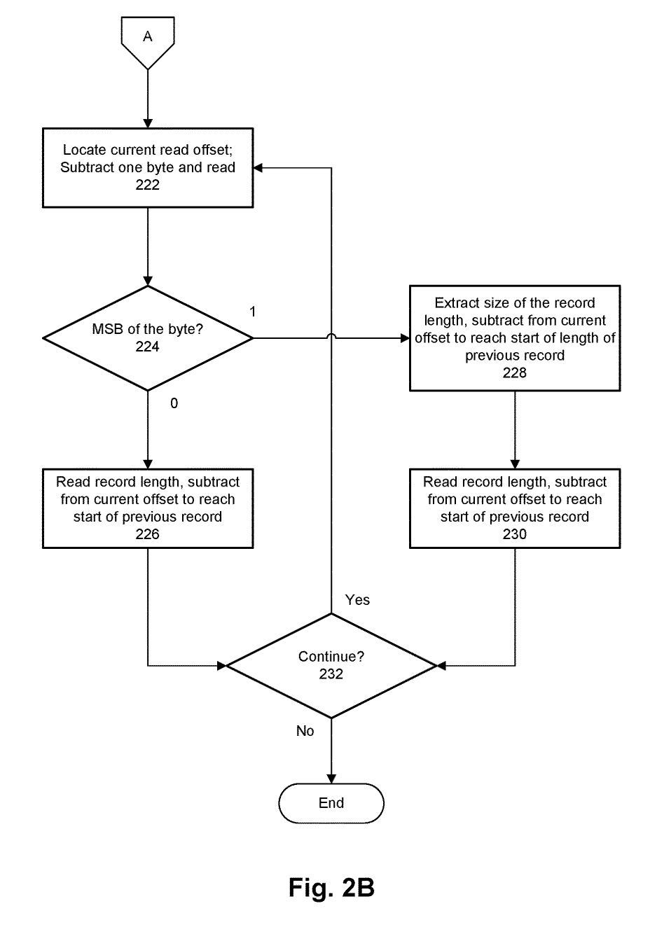

FIGS. 2A-B comprise a flow chart illustrating a method of facilitating reverse reading of sequentially stored variable-length data, according to some embodiments. In other embodiments, one or more of the illustrated operations may be omitted, repeated, and/or performed in a different order. Accordingly, the specific arrangement of steps shown in FIG. 2 should not be construed as limiting the scope of the embodiments.

In these embodiments, one or more data repositories (e.g., databases, files or file systems) sequentially store the variable-length data as individual records, each of which has a corresponding length (or size) that can be measured in terms of bytes (or other units). The manner in which the records are stored facilitates their reading in reverse order, and the manner in which they are reverse-read (i.e., read in reverse order) depends on how they are stored.

In operation 202 of the illustrated method, a new set of data is received for storage. If not already in a form to be stored, it may be assembled into a record, which may involve compressing the data, encoding or decoding it, encrypting or decrypting it, and/or some other pre-processing. In some implementations, no pre-processing is required because the data can be stored in the same form in which it is received.

In operation 204, the end of the previously stored record is identified (including associated size metadata), which may be readily available in the form of a pointer or other reference that identifies a current write offset within the data repository. If the data are to be stored in a new data repository that contains no other records, this current write offset may be the first storage location of the repository.

In operation 206, the data are written with suitable encoding, which may vary from one implementation to another. Before, after, or as the data are written, the length of the written data record is determined (e.g., as a number of bytes occupied by the record).

In operation 208, the record length is written with variable-length quantity (VLQ) encoding, which is described above. Specifically, the binary representation of the record length is divided into 7-bit groups, starting from the least significant bit, so that if the length is 128 bytes or greater (i.e., length ≧2⁷) only the group containing the most significant bits may contain less than 7 bits, which is padded with zeros to form a 7-bit group.

Each 7-bit group is stored after the data record in a separate octet (or byte), in order, from the most significant to least significant. The most significant bits (or sign bits) of all but the last (least significant) octet are set to 1 to indicate, when the record length is read in the same order in which it was written, that there is at least one more octet to be read in order to assemble the record length. The most significant bit of the last octet is set to 0 to indicate that it is the final portion of the record length. Similarly, if the record length is less than 128 bytes, and can be stored in a single octet, the most significant bit of that octet is set to 0.

In operation 210, the data writer (e.g., writer 112 of system 110 of FIG. 1) or a process/entity that controls the writer determines whether the record length was 128 bytes or more or, in other words, whether more than one octet or byte was used to store the record length. If so, the method continues at operation 212; otherwise, the method advances to operation 220.

In operation 212, the ‘size of the size’, or the number of bytes needed to store the record length, is stored in the least significant bits of an additional octet/byte, and the value 1 is stored in the most significant bit. Because this ‘size of the size’ byte can store a value of up to 127 (in base-10), it can report a record length of up to 127 bytes, which corresponds to a record that is far larger than existing computer architectures can (or need to) accommodate (i.e., 2^{(127×7)}−1).

In operation 220, a new data request is received—either a request to store a new set of data or a request to retrieve a previously stored set of data. If the request is a write request, the method returns to operation 202; if the request is a read request, the method advances to operation 222 (FIG. 2B). In some embodiments, such as when separate processes handle the different types of data requests, some operations may be handled in parallel.

In operation 222, the current read offset is identified or located (e.g., with a read pointer), which may be the end of the size metadata of the final record that was stored in the repository, or the end of some other set of size metadata. The value of one byte is subtracted from the current offset and that byte (which is the final byte of the size metadata of the previous or preceding record in the repository) is read.

In operation 224, the most significant bit of the current byte is identified. If the MSB has the value 0, the method continues at operation 226; otherwise, the method advances to operation 228.

In operation 226, the current byte stores the length (or size) of the preceding record (the ‘next’ record in reverse order), in bytes, and that value (up to 127 in decimal notation) is subtracted from the current offset in order to reach the start of the preceding record. The method then advances to operation 232.

In operation 228, the lower 7 bits of the current byte are extracted, which store the size of the length of the preceding record, in bytes. That value (up to 127 in decimal notation) is subtracted from the current read offset to identify the offset of the VLQ-encoded record length.

In operation 230, the record length is read and subtracted from the current offset to identify and reach the start of the preceding record (which makes it the ‘current’ record).

In operation 232, if the reverse navigation/traversal of the data records is finished (e.g., the current record is the last/only record sought in the read request), the method ends or returns to a previous operation (e.g., operation 220 to receive a new data request). Otherwise, the method returns to operation 222 to locate the start of the previous record.

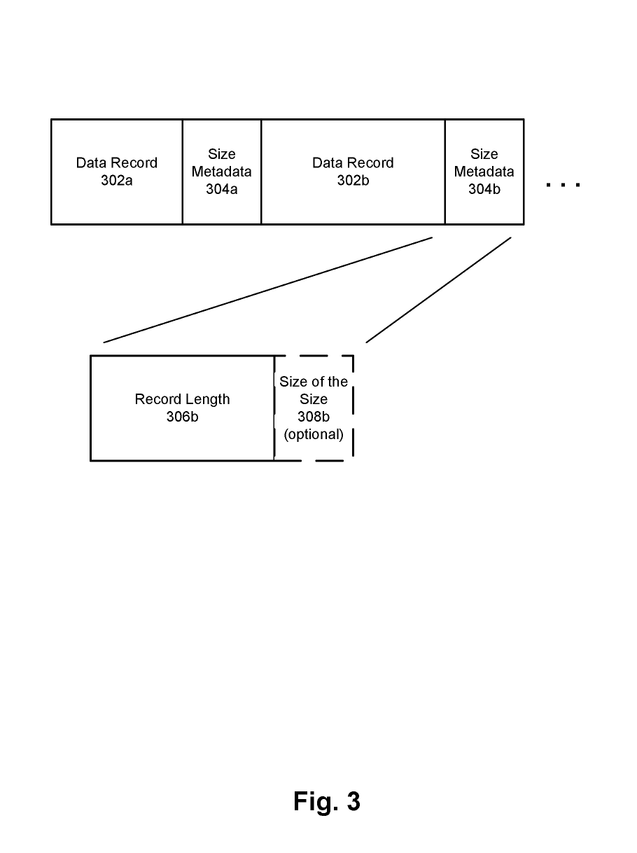

FIG. 3 is a block diagram depicting sequential storing of variable-length data to facilitate reverse reading, according to some embodiments.

In these embodiments, data records 302 (e.g., records 302a, 302b) have varying lengths (or sizes), and are stored sequentially with accompanying size metadata 304 (e.g., metadata 304a, 304b). Any number of records (and corresponding size metadata) may be stored, and the repository of the data may be a text file, a log-structured database, or have some other form, and may reside on a magnetic or optical disk, a flash drive, a solid state drive, or some other hardware.

Illustrative size metadata 304b includes record length 306b, which identifies the length (e.g., in bytes) of corresponding data record 302b, and optional size of the size 308b, which, if present, identifies the size (or length) of record length 306b (e.g., in bytes).

As discussed above, in some embodiments, a size of the size value (e.g., size of the size 308b) is only added to the size metadata when the record length value is at least 128 bytes; representing the value therefore requires two or more bytes or octets of variable-length quantity encoding, which comprise record length 306b.

### Storing and Indexing Sequentially Stored Variable-Length Data

In some embodiments, a system, method, and apparatus are provided for indexing and sequentially storing variable-length data records. In these embodiments, the index is embedded with the stored data and facilitates rapid key-based data retrieval. In some implementations, the index is stored separate from the database, file, log, or other repository that stores the data, and can be readily constructed or reconstructed by scanning the repository. As discussed above, the manner in which the data are stored facilitates reverse-scanning, so that the most recently stored records can be read first.

Within the repository, each data record includes some number of key fields (e.g., one or more), with each key having some number of possible values (e.g., two or more). For each possible value for each key field, the index stores offsets, pointers, or other references to a record (e.g., the most recently stored record) that includes that value for the corresponding key. That record (and every other stored record) includes, for each key field, an offset or other reference to another record (e.g., the next-most recently stored record) that has the same value for that key field. The index thus identifies a first record having each value of each key, and that record identifies a subsequent record having the same value for that key, and also identifies subsequent records having the values of its other key fields. Each subsequent record identifies yet other records having the same values for its key fields, and so on.

If no record in the repository has a given value for a given key, the index will store a predetermined value (e.g., null, zero). Similarly, for the last record (e.g., the oldest record) that has the given value for the key, the key's corresponding offset will have that same predetermined value.

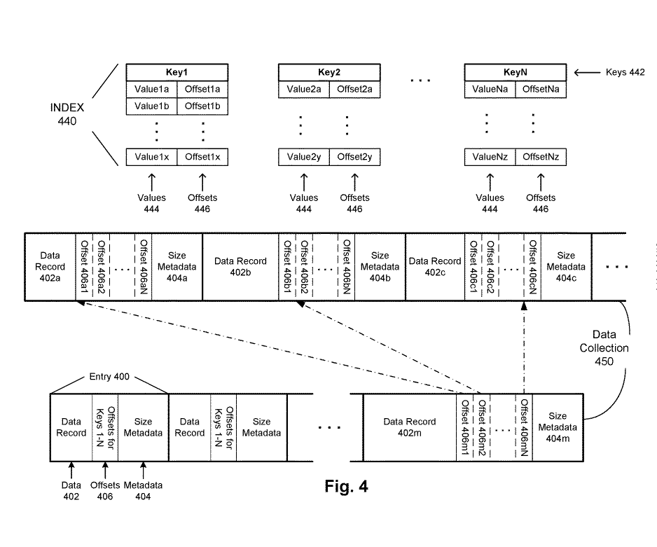

FIG. 4 is a block diagram depicting indexed storage of variable-length data so as to facilitate reverse reading, according to some embodiments. In these embodiments, data are stored as records within data collection 450, which may be a file, a database, or have some other form or structure. Index 440 is associated with data collection 450.

Index 440 includes information for each of N multiple keys 442 (or key fields) included in every data record. A given key in a given record may be a substantive value or may be null (or some other predetermined value) to indicate that it has no value for that record.

For each key 442, index 440 comprises a table (e.g., a hash table), list, or other structure that identifies values 444 of the key and corresponding offsets 446 to first (e.g., most recently stored) records having the values. Thus, for each value for each of the N keys, index 440 identifies (via an offset) a first record having a given value for a given key. As indicated above, if no record in data collection 450 includes a particular value 444 for a particular key 442, the corresponding offset 446 will be null or some other predetermined value (e.g., 0).

It may be noted that index information for a particular key 442 may be initialized at the time index 440 is created if all values for the key are known, or the index information (e.g., a table corresponding to the particular key) may be appended to as new values are encountered (e.g., as new data records are stored). For example, if the particular key corresponds to days of the week, then all seven values are known ahead of time. By way of contrast, for a key that corresponds to identifiers of members of a user community, new values will be continually encountered.

Illustrative entry 400 in data collection 450 comprises data portion 402 that stores a data record, metadata portion 404 that stores size metadata, and an offsets portion 406 that stores offsets to subsequent entries or data records. Similarly, the entry containing or associated with data record 402a includes the data record, size metadata 404a, and offsets 406a (offsets 406a1-406aN). Further, data record 402b has associated size metadata 404b and offsets 406b (offsets 406b1-406bN), data record 402c has associated size metadata 404c and offsets 406c (offsets 406c1-406cN), and the entry containing data record 402m also comprises size metadata 404m and offsets 406m (offsets 406m1-406mN).

Data records 402 in FIG. 4 may be stored in a similar or identical fashion to data records depicted in FIG. 3 (e.g., records 302a, 302b). For example, a record or other set of data may be stored as it is received at a database or other entity configured to write data to data collection 450. Size metadata 404 in FIG. 4 may be stored in a similar or identical fashion to size metadata depicted in FIG. 3 (e.g., size metadata 304a, 304b). In particular, size metadata in data collection 450 may comprise ‘size of size’ values that assist reverse navigation through data collection 450. Individual key offsets within offsets portion 406 of an entry may be stored in the same or similar manner to size metadata 404 (e.g., with variable-length encoding, with ‘size of the size’ bits).

With each entry of data collection 450, offsets portion 406 includes the same number of offsets, each one corresponding to one of keys 442. Thus, for N keys, each offset portion 406 includes N offsets. The order of offsets within offsets portions 406 may or may not match the order of keys 442 in index 440, but the offsets are stored in the same order among all offset portions 406 in data collection 450. This order is known (e.g., may be programmed into) processes that scan, navigate, read from, write to, or otherwise traverse the data collection (e.g., to respond to queries, to store new data).

To aid the description of embodiments disclosed herein, offsets within an offsets portion 406 of an entry of data collection 450 may be termed ‘key offsets,’ while offsets 446 of index 440 may be termed ‘index offsets’.

In some implementations, both index offsets 446 and key offsets 406 are absolute offsets (i.e., from the start of data collection 450 or the start of a file or other structure that includes collection 450). In other implementations, both types of offsets are relative offsets. In yet other implementations, some offsets (e.g., index offsets) are absolute while others (e.g., key offsets) are relative.

Illustratively, when an index offset 446 is a relative offset, it may be measured from the start, the end, or some other point of index 440, or from the storage location of the index offset. When a key offset 406 in an entry in data collection 450 is a relative offset, it may be measured from the start of the entry, the start of the key offset, or some other point.

An offset (an index offset or a key offset) may identify the starting point (e.g., byte) of a target entry (i.e., the first byte of the entry's data record), the starting point of the offsets portion within a target entry, or the starting point of a specific key offset within a target entry. In the latter scenario, a scan or traversal of data collection 450 for some or all records having a particular value for a particular key can quickly navigate all pertinent records by finding a first index offset 446 (for the particular value 444 of particular key 442), using that to identify a corresponding key offset 406 (for the same key) within a first entry, and thereafter following a sequence of key offsets in different entries to identify the records.

This is partially illustrated in FIG. 4, wherein three key offsets 406 (i.e., offsets 406m1, 406m2, 406mN) associated with data record 402m correspond to values for three keys 442 (i.e., keys 1, 2, and N). Because data record 402m is the last record (e.g., the most recently stored record) in collection 450, the values that keys 1, 2, and N carry within record 402m will be stored among values 444, and their corresponding offsets 446 will reference (i.e., be offsets to) key offsets 406m1, 406m2, and 406mN.

Similarly, key offsets 406m1, 406m2, 406mN for data record 402m are offsets to corresponding key offsets of other entries in collection 450. Thus, key offset 406m1 is an offset to key offset 406a1 (associated with data record 402a), key offset 406m2 is an offset to key offset 406b2 (associated with data record 402b), and key offset 406mN is an offset to key offset 406cN (associated with data record 402c).

The indexing and storage scheme depicted in FIG. 4 thus facilitates forward or reverse reading or scanning (using size metadata as described in a previous section for reverse navigation), as well as rapid access to some or all data entries having a specific value for a specific key field (using the corresponding index offset and key offsets).

In some embodiments, the term ‘record’ or ‘data record’ may encompass an entire entry in data collection 450, including the data and offsets portions, and possibly also encompassing the metadata portion. Thus, a reference (e.g., an offset) to a data record may comprise a reference to any portion of the entry that comprises the data record.

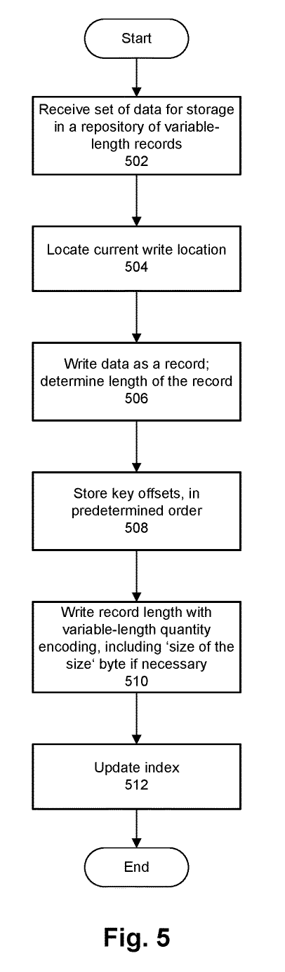

FIG. 5 is a flow chart illustrating a method of appending a new entry to an existing repository of sequentially stored, variable-length data, such as data collection 450 of FIG. 4, according to some embodiments. In other embodiments, one or more of the illustrated operations may be omitted, repeated, and/or performed in a different order. Accordingly, the specific arrangement of steps shown in FIG. 5 should not be construed as limiting the scope of the embodiments.

In operation 502, a set of data is received for storage. The data may be stored as is, meaning that the set of data is a complete data record (such as one of data records 402 of FIG. 4), or may be configured or formatted if necessary or desired (e.g., to encrypt or decrypt it, to apply some encoding) to form a data record.

For the value of each key field of the data record, the index associated with the data repository is scanned to identify the corresponding index offsets. For key values identified in the index but not represented in previously stored data, the index offset will be a predetermined value (e.g., null, 0). If the data record includes a new value for a given key, the value is added to the index.

In operation 504, the current write location within the data repository is identified (e.g., using a write pointer or write offset), and will be updated when the entry is complete.

In operation 506, the data record is written at the current write location. The size of the data record may be determined at this time, to assist in configuration of the size metadata.

In operation 508, immediately following the data record, the index offsets read from the index are stored in a predetermined order as key offsets (e.g., the order of the keys in the index, some other specified order). In some implementations, the index offsets may be converted in some way prior to being stored as key offsets. For example, if the index offsets are absolute offsets, they may be converted to relative offsets based on the starting points (e.g., bytes) of the key offsets before the key offsets are written.

In operation 510, the record length (i.e., the entry's size metadata) is written following the last key offset, in the same or a similar manner as discussed in the previous section. This operation may therefore include determining whether a ‘size of the size’ byte is needed, and including that byte in the record length if it is required.

For the purpose of measuring the size of a data record, the key offsets may be considered part of the record. In this case, when the size metadata is later read, it directly identifies (an offset to) the start of the data record. In some implementations, however, the key offsets may not be considered part of the data record for the purpose of computing the size metadata. Because the number of key offsets is known (i.e., the number of key fields in every data record), and their sizes may be predetermined, the storage space occupied by the key offsets can be easily computed and accounted for when (reverse) scanning entries in the data repository).

Thus, key offsets may be of fixed size, which may be determined by the size (or a maximum size) of the data repository. As one alternative, key offsets may be formatted and stored in the same manner as size metadata portions of entries illustrated in FIGS. 3 and/or 4 (e.g., with variable-length encoding).

In operation 512 the index is updated. Specifically, for each key value of the data record, the corresponding index offset is updated to store an offset to the corresponding key offset of the data record's entry in the data repository.

Although the method of FIG. 5 assumes one or more entries were previously stored in the data repository, a method of storing a first entry in an empty or new data repository may be readily derived from the preceding discussion. Illustratively, the entry would be stored at a first storage location in the repository (formatted as indicated above), and an index would be created or initialized based on values of the key fields of the data record and offsets to the entry (or to key field offsets within the entry).

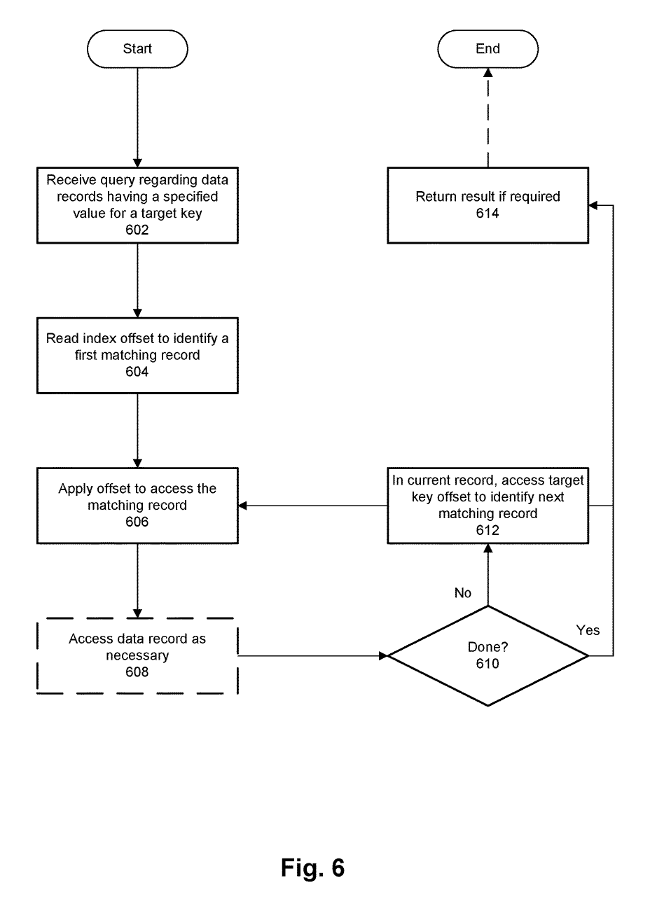

FIG. 6 is a flow chart illustrating a method of retrieving one or more sequentially stored variable-length records having a particular key value, according to some embodiments. In other embodiments, one or more of the illustrated operations may be omitted, repeated, and/or performed in a different order. Accordingly, the specific arrangement of steps shown in FIG. 6 should not be construed as limiting the scope of the embodiments.

In operation 602, a query is received regarding one or more records, within a data repository, that have a particular value for a specified or target key. For example, some number of records may be desired that pertain to a particular member of a user community; that have timestamps that include the same month, day, hour or other time period; that reference a content item having a particular identifier; etc.

In operation 604 the index for the data repository is consulted to identify, for the specified value for the target key, an index offset to a first matching record (e.g., the most recently stored matching record).

In operation 606, the index offset is used or applied to locate the matching record/entry in the data repository. In some embodiments, for example, the index offset may identify the starting point of the data record (i.e., the data portion of the entry); in other embodiments, it may identify the start of the target key offset (i.e., the key offset corresponding to the target key); in yet other embodiments it may identify some other portion of the matching data record's entry.

In optional operation 608, the data record may be accessed if necessary or desired. For example, the query may request some portion of the data of matching data records. Conversely, simply a count of matching records may be desired, in which case the data record need not be read.

If the data record does need to be read, and the offset that led to the current record identified the start of the target key offset, in the illustrated method the rest of the key offsets after the target key offset are skipped to access the entry's size metadata, which are applied as described in the previous section to access the start of the data record.

In operation 610, a determination is made as to whether the search/navigation is complete. Illustratively, if only a subset of all matching records was required (e.g., a specified number of records, all records within some time period or matching other criteria), the search may be complete and the method advances to operation 614.

Otherwise, if the search is not complete, in operation 612 the target key offset of the current matching record is read to obtain an offset to a next matching record (e.g., the next most recently stored matching record), and the method then returns to operation 606.

In operation 614, a result is returned if necessary or required, which may include data extracted from one or more matching records, a count of some or all matching records, and/or other information.

It may be noted that if the index for the data repository is not available or is inaccessible, the format in which data are stored allows rapid key value-based retrieval of records. In particular, the size metadata of entries in the repository facilitates reverse-scanning of the entries until a first (most recent) entry having the target key value is found, after which the key offsets of matching entries can be quickly traversed. Similarly, the index can be readily reconstructed by reverse-scanning the data until all values for all keys are found.

### An Illustrative Apparatus for Sequentially Stored Variable-Length Data

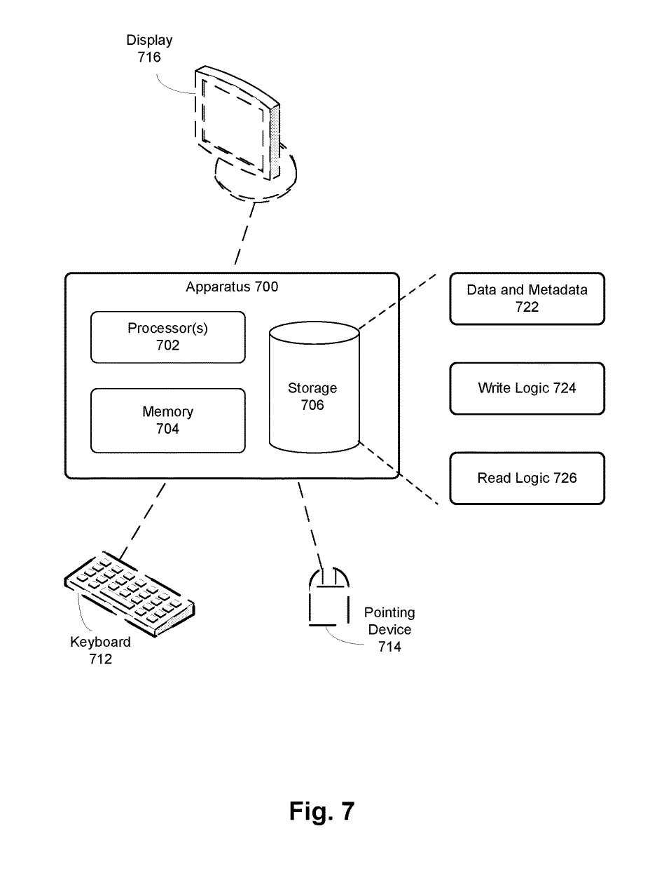

FIG. 7 depicts an apparatus for facilitating reverse reading of sequentially stored variable-length data and/or indexing and sequentially storing such data, according to some embodiments.

Apparatus 700 of FIG. 7 includes processor(s) 702, memory 704, and storage 706, which may comprise any number of solid-state, magnetic, optical, and/or other types of storage components or devices. Storage 706 may be local to or remote from the apparatus. Apparatus 700 can be coupled (permanently or temporarily) to keyboard 712, pointing device 714, and display 716.

Storage 706 is (or includes) a data repository that stores data and metadata 722. Data and metadata 722 includes variable-length data records that are stored sequentially with corresponding size metadata.

As described above, for example, the size metadata for a given record may include one or more bytes (or other storage units) that identify the length of the record (e.g., with variable-length quantity (VLQ) encoding). If more than one storage unit (or byte) is needed to store the record length, the record's size metadata includes an additional byte that identifies the size/length of the record length (e.g., the number of bytes used to store the record length). When the record length is stored with VLQ encoding, the most significant bit of the additional byte is set to one so that, during reverse reading, the reader can quickly determine that the byte does not store the record length, but rather the length (e.g., number of bytes) of the record length (or ‘size of the size’).

In addition, for each record, one or more key offsets are stored that store offsets to other records having the same values for the same keys. Thus, for a given value for a given key, corresponding key offsets associated with records having that key value can be quickly traversed.

An index for identifying initial (e.g., most recently stored) records that have each value of each key may be included in storage 706 or may be stored separately. For example, the index may be maintained in memory 704.

Storage 706 also stores logic and/or logic modules that may be loaded into memory 704 for execution by processor(s) 702, including write logic 724 and read logic 726. In other embodiments, these logic modules may be aggregated or divided to combine or separate functionality as desired or as appropriate. For example the write logic and read logic may be combined into a larger logic module that handles input/output for the data repository.

Write logic 724 comprises processor-executable instructions for writing to data 722 a new data record and accompanying/corresponding key offsets and size metadata. Thus, for each new set of data to be stored, write logic 724 writes the data, writes a key offset for each key field, determines the length of the new data record (possibly including the key offsets), writes the length after the data and, if more than one byte (or other threshold) is required to store the length, writes the additional size metadata byte (e.g., the ‘size of the size’ byte). Write logic 724 may also be responsible for updating an index associated with the data (e.g., to store offsets to the new data record (or the new data record's key offsets) among the index offsets).

Read logic 726 comprises processor-executable instructions for forward-reading and/or reverse-reading data and metadata 722. While reading the data in reverse order, for each record the reader logic first reads the last byte of the corresponding size metadata. If its most significant bit is zero, the byte stores the record's length and the reader can quickly calculate the offset to the start of the record and move there to read the record. If the most significant bit of the last byte is one, the rest of the last byte identifies the size of (e.g., number of bytes used to store) the record length. The reader logic can therefore quickly find the offset of the beginning of the length, read the length, and use it to calculate the start of the record.

Illustratively, in response to a read request or query specifying one or more attributes or characteristics of a desired data record (or set of records), other than by a value of a key field, and particularly when the most recent record(s) or most recent version of the desired record(s) are desired, read logic 726 traverses data 722 in reverse order from some starting point (e.g., the end of file, the starting offset of the last data record that was read). The read logic then navigates the data as described above. As the starting offset of each succeeding record is determined, some or all of the record may be read to determine whether it should be returned in response to the request or query.

Read logic 726 is also configured to use an associated index to locate a first (e.g., most recently stored) record having particular values for one or more specified or target keys or key fields. Using index offsets, the first record is located, after which that record's key offsets are used to quickly find other records satisfying the same criteria.

Sequentially stored variable-length data records of data 722 may also (or instead) be read or traversed in reverse order (or, conversely, in the order they were stored) for some other purpose, such as to assemble an index or linked list of records, to purge and compress the data, etc.

An environment in which one or more embodiments described above are executed may incorporate a data center, a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

1. A method of indexing and sequentially storing variable-length data records, the method comprising:
obtaining a first data record having one or more keys with corresponding values;
for each key, retrieving from an index an index offset to a previously stored data record having the corresponding value;
storing the first data record;
adjacent to the first data record, storing key offsets derived from the retrieved index offsets; and
for each key, updating the index offset to reference the first data record instead of the previously stored data record.

2. The method of claim 1, wherein the index comprises:
for each of the one or more keys, at least one value; and
for each value of each of the one or more keys, an associated index offset to a stored data record having the value.

3. The method of claim 1, wherein:
the updated index offsets are offsets to a start of the first data record.

4. The method of claim 1, wherein:
for each key, said retrieving from the index an index offset to a previously stored data record having the corresponding value includes retrieving a first index offset for a first key;
said storing the retrieved index offsets as key offsets includes storing a first key offset comprising the first index offset; and
the updated first index offset is an offset to the first key offset.

5. The method of claim 1, further comprising:
(a) receiving a request for one or more data records having a specified value for a specified key;
(b) retrieving from the index a first index offset to a data record comprising the specified value for the specified key;
(c) accessing the data record;
(d) reading a key offset associated with the data record and corresponding to the specified key, wherein the key offset identifies a next data record comprising the specified value for the specified key;
(e) accessing the next data record; and
(f) repeating (d) and (e) until the request is satisfied.

6. The method of claim 1, wherein:
the index offsets are absolute offsets; and
the key offsets are relative offsets.

7. The method of claim 1, wherein:
the index offsets are absolute offsets;
the key offsets are relative offsets; and
storing a given key offset derived from a given retrieved index offset comprises converting the absolute offset of the given retrieved index offset to a relative offset from the given key offset.

8. The method of claim 1, further comprising:
determining a combined length of the data record and the key offsets;
storing the combined length;
determining the size of the combined length; and
when the size of the combined length is greater than a threshold, storing one additional byte following the combined length, wherein:
the most significant bit of the one additional byte is set to 1; and
remaining bits of the one additional byte identify the size of the combined length.

9. An apparatus for indexing and sequentially storing variable-length data records, the apparatus comprising:
one or more processors; and
memory storing instructions that, when executed by the one or more processors, cause the apparatus to:
obtain a first data record having one or more keys with corresponding values;
for each key, retrieve from an index an index offset to a previously stored data record having the corresponding value;
store the first data record;
adjacent to the first data record, store key offsets derived from the retrieved index offsets; and
for each key, update the index offset to reference the first data record instead of the previously stored data record

10. The apparatus of claim 9, wherein the index comprises:
for each of the one or more keys, at least one value; and
for each value of each of the one or more keys, an associated index offset to a stored data record having the value.

11. The apparatus of claim 9, wherein:
the updated index offsets are offsets to a start of the first data record.

12. The apparatus of claim 9, wherein:
for each key, said retrieving from the index an index offset to a previously stored data record having the corresponding value includes retrieving a first index offset for a first key;
said storing the retrieved index offsets as key offsets includes storing a first key offset comprising the first index offset; and
the updated first index offset is an offset to the first key offset.

13. The apparatus of claim 9, wherein the memory further stores instructions that, when executed by the one or more processors, cause the apparatus to:
(a) receive a request for one or more data records having a specified value for a specified key;
(b) retrieve from the index a first index offset to a data record comprising the specified value for the specified key;
(c) access the data record;
(d) read a key offset associated with the data record and corresponding to the specified key, wherein the key offset identifies a next data record comprising the specified value for the specified key;
(e) access the next data record; and
(f) repeat (d) and (e) until the request is satisfied.

14. The apparatus of claim 9, wherein:
the index offsets are absolute offsets; and
the key offsets are relative offsets.

15. The apparatus of claim 9, wherein:
the index offsets are absolute offsets;
the key offsets are relative offsets; and
storing a given key offset derived from a given retrieved index offset comprises converting the absolute offset of the given retrieved index offset to a relative offset from the given key offset.

16. The apparatus of claim 9, wherein the memory further stores instructions that, when executed by the one or more processors, cause the apparatus to:
determine a combined length of the data record and the key offsets;
store the combined length;
determine the size of the combined length; and
when the size of the combined length is greater than a threshold, store one additional byte following the combined length, wherein:
the most significant bit of the one additional byte is set to 1; and
remaining bits of the one additional byte identify the size of the combined length.

17. A system for indexing and sequentially storing variable-length data records, comprising:
at least one processor; and
a data storage module comprising a non-transitory computer-readable medium storing instructions that, when executed, cause the system to:
obtain a first data record having one or more keys with corresponding values;
for each key, retrieve from an index an index offset to a previously stored data record having the corresponding value;
store the first data record;
adjacent to the first data record, store key offsets derived from the retrieved index offsets; and
for each key, update the index offset to reference the first data record instead of the previously stored data record.

18. The system of claim 17, wherein the non-transitory computer-readable medium of the data storage module further stores instructions that, when executed, cause the system to:
(a) receive a request for one or more data records having a specified value for a specified key;
(b) retrieve from the index a first index offset to a data record comprising the specified value for the specified key;
(c) access the data record;
(d) read a key offset associated with the data record and corresponding to the specified key, wherein the key offset identifies a next data record comprising the specified value for the specified key;
(e) access the next data record; and
(f) repeat (d) and (e) until the request is satisfied.

19. The system of claim 17, wherein:
the index offsets are absolute offsets;
the key offsets are relative offsets; and
storing a given key offset derived from a given retrieved index offset comprises converting the absolute offset of the given retrieved index offset to a relative offset from the given key offset.

20. The system of claim 17, wherein the non-transitory computer-readable medium of the data storage module further stores instructions that, when executed, cause the system to:
determine a combined length of the data record and the key offsets;
store the combined length;
determine the size of the combined length; and
when the size of the combined length is greater than a threshold, store one additional byte following the combined length, wherein:
the most significant bit of the one additional byte is set to 1; and
remaining bits of the one additional byte identify the size of the combined length.
